(19) United States
(12) Patent Application Publication
(10) Pub. No.: US 2022/0046324 A1
(43) Pub. Date: Feb. 10, 2022

(54) SYSTEM AND METHOD FOR THE COMMON CONTROL OF HETEROGENEOUS MEDIA SERVICE RESTRICTIONS

(71) Applicant: ARRIS ENTERPRISES LLC, Suwanee, GA (US)

(72) Inventors: Vinod Jatti, Bengaluru (IN); Virendra Singh, Bangalore (IN)

(73) Assignee: ARRIS ENTERPRISES LLC, Suwanee, GA (US)

(21) Appl. No.: 17/369,194

(22) Filed: Jul. 7, 2021

Related U.S. Application Data
(60) Provisional application No. 63/062,653, filed on Aug. 7, 2020.

(51) Int. Cl. H04N 21/475; H04N 21/258; H04N 21/4415; H04N 21/45

(52) U.S. Cl. CPC H04N 21/4753; H04N 21/4532; H04N 21/4415; H04N 21/25875

(57) ABSTRACT

A system and method for determining if a user should be prohibited from accessing over-the-top (“OTT”) content in accordance with predetermined content restrictions within a media gateway appliance (“MGA”). If the OTT source provides a restriction rating for the content, the rating is compared to content restrictions stored in the MGA to determine if access should be restricted. Access to restricted content will only be granted if the user provides the proper key code. This key code is the same one utilized for accessing restricted non-OTT content. If the OTT content has no associated rating, the content is analyzed to determine an equivalent rating. This equivalent rating is compared to content restrictions stored in the MGA to determine if access should be granted, or if entry of the key code will be required. User biometrics may also be utilized to further verify authorized users.

### CROSS-REFERENCE TO RELATED APPLICATION

This application claims the benefit of U.S. Provisional Patent Application No. 63/062,653, filed Aug. 7, 2020, which is incorporated by reference herein in its entirety.

### BACKGROUND OF THE INVENTION

Media gateway appliances (“MGAs”), such as set-top boxes associated with cable, optical and satellite broadband systems, serve as the primary conduit for media services, including streaming media obtained from a multiservice operator (“MSO”), as well as so-called over-the-top streaming media (“OTT media”). OTT media is typically received from sources via the Internet, bypassing the controls and protocols imposed by an MGA provided by a given MSO. Examples of OTT sources include Netflix, Amazon Prime and Hulu.

The number of OTT providers continues to grow, and MGAs are more and more often being utilized to support the viewing of OTT content. As mentioned above, the very nature OTT media services enables them to bypass the controls and protocols typically associated with an MGA. Of primary concern among these would be parental controls. Most MSOs provide their customers with MGAs adapted to enable end-users to restrict access to certain types of content that might not be considered appropriate for younger viewers. This restriction is often based upon either the rating of the content (Y7, PG, MA, etc.) and/or the particular channel on which the content is being received source (an all-news channel could be considered as potentially upsetting for younger viewers). Metadata indicative of the rating is embedded in the media. When the parental restriction has been enabled, an MGA will not permit viewing of the restricted content without authorization from the end-user (typically a multi-digit code keyed into a remote control by an end-user). OTT content would not be subject to the parental restrictions as the MGA is simply being used as a conduit for the incoming content. The title, subject matter and the rating of received OTT content is unknown to the MGA.

This scenario leads to conditions that would any user of the MGA, including children, to gain unlimited and unregulated access to OTT content. A parent or guardian would have had to implement a complete restriction of all OTT services, unless the proper code was keyed in. This might be undesirable as there is substantial OTT content that would likely be considered acceptable, or even educational for younger viewers, and a parent or guardian might wish to encourage proactive and unsupervised viewing of such. Present MGA content restriction systems do not provide a means by where OTT content or content ratings can be suitably identified to permit selective viewing restrictions to be imposed. Although many of the OTT services do enable users to apply parental controls, each of these services (Netflix, Amazon Prime, Hulu, etc.) would require that the parameters defining parental restrictions be entered by an end-user, and would then require the entry of a particular code to enable viewing of any restricted content. This gives rise for an end-user having to repeat what is likely a tedious programming process for each of the OTT providers in order to define the desired content restrictions, and then to enter a code, specific to a given OTT service, each time restricted content was to be accessed for viewing. This does not give rise to a particularly user-friendly viewing environment.

It would therefore be desirable to provide a system and method for implementing a single content restriction control protocol across both MSO content and OTT content. This system and method would ideally apply a single standard for content restriction across all media being access via an MGA and require only one common code to be provided to override the restriction.

### BRIEF SUMMARY OF THE INVENTION

A system and method for determining if a user should be prohibited from accessing OTT content in accordance with predetermined content restrictions stored within an MGA. The system and method determine if the OTT source has provided a restriction rating for the content. If so, the associated rating is retrieved and compared to the content restrictions stored in the MGA to determine if access should be restricted. Access to restricted content will only be granted if the user can provide the proper key code. This key code is the same one utilized for accessing restricted non-OTT content. If the OTT content has no associated rating, then content is analyzed to determine an equivalent rating. This equivalent rating is then compared to the content restrictions stored in the MGA to determine if access should be granted or if the entry of the key code is required. The system and method also provide for the collection of user biometrics for purposes of further verifying authorized users.

### BRIEF DESCRIPTION OF THE DRAWINGS

The aspects, and advantages of the present invention will become better understood with regard to the following description, appended claims, and accompanying drawings in which:

FIG. 1 is a is a functional block diagram of a system supporting a preferred embodiment of an automatic system for recording viewer reactions.

FIG. 2 is a process flow diagram of steps associated with a media gateway device supporting a preferred embodiment of an automatic system for recording viewer reactions.

FIG. 3 is a functional block diagram of a system comprising a plurality of media gateway appliances supporting a supp

FIG. 4 is a process flow diagram of steps associated with implementing a preferred embodiment of an automatic system for recording viewer reactions.

### DETAILED DESCRIPTION

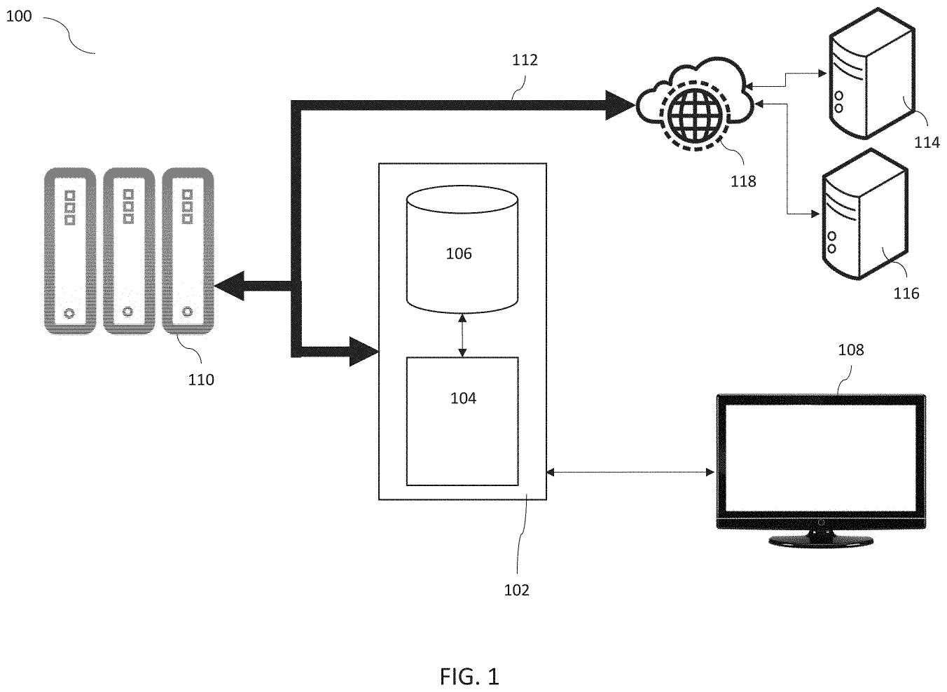

FIG. 1 is a functional block diagram of a preferred embodiment of a system (100) including MGA 102 and enabling the selection, streaming and viewing of media content. As shown, system 100 comprises MGA 102 which is adapted to manage the transmission, reception, recording, storage and viewing of multiple types of digital media and digital communications. MGA 102 includes processor 104 and memory 106. Processor 104 is also shown to be in communication with television 108. In addition, MGA 102 is linked to multiservice operator (“MSO”) 110 via broadband connection 112, and to OTT services 114 and 116 via broadband connection 114 and Internet 118.

Processor 104 is adapted to execute a media management application that, in response to commands received from a user or the MSO, restricts access to and viewing of media content received via MGA 102. Memory 106 provides a repository for the media management application, user-specific viewing permissions, and end-user passwords.

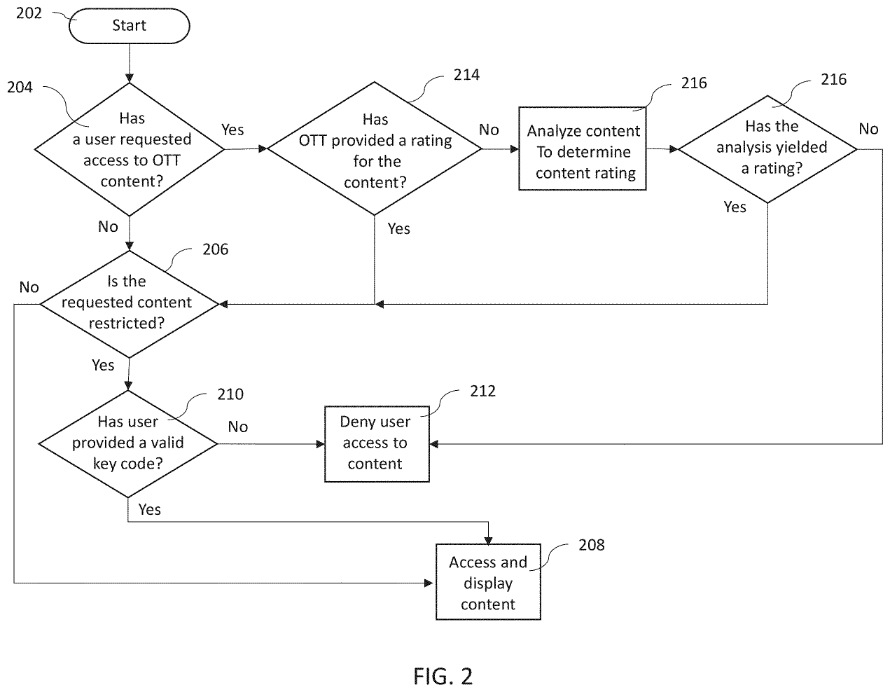

FIG. 2 provides a flow diagram of the content restriction process carried out within MGA 102 in response to a user request for content and in accordance with a first particular embodiment. In steps 202 and 204, processor 104 within MGA 102 determines if the request was for OTT content. If not, the process continues with step 206 and a determination is made as to whether the requested non-OTT content is restricted under the present constraints programmed into MGA 102 (the parameters for such constraints are stored in Memory 106). If the content is not restricted, access is granted and the content is displayed (step 208). If the content is restricted, the process continues with step 210 and processor 104 determines if the user has provided the proper key code to gain access to the content. This key code could be programmed into the MGA by the end-user or set by the provided of the MGA (such as an MSO). Use of such key codes are common for controlling access to restricted content on MGAs. If the proper code was provided, access is granted and the content is displayed (step 208). If the user failed to provide the proper key code, access to the requested content is denied (step 212). Processor 104 will then generate an indication that the user has been denied access to the requested content. This indication can be audible and/or visual and can be delivered to the user via a user interface, such as television 108. This operation of an MGA with respect to the application of restrictions to non-OTT, MSO-provided content is well-known and will not be discussed in any further detail.

If in step 204 processor 104 made the determination that a user had requested OTT content, the process continues with step 214. Processor 104 checks to see if the OTT has appended or associated any rating information with the requested content. Such information could be embedded within the content data stream, or it could be retrieved separately from the OTT in accordance with a particular Application Protocol Interface (“API”) provided to the MGA by the OTT or the MSO. If the OTT has provided a content rating, the process continues with step 206 and the access will be granted or denied passed upon the content rating and the provision of a valid key code (steps 206-212). Processor 104 will then generate an indication that the user has been denied access to the requested content. This indication can be audible and/or visual and can be delivered to the user via a user interface, such as television 108. However, if the OTT has failed to provide a content rating, processor 104 initiates a rating determination process (step 216. This process could be based upon a) analyzing the content to so as to recognize the title or other indicia of identity and then search networked sources (including the Internet) to determine the rating of the identified content, or b) utilization of artificial intelligence (“AI”) to analyze the content on the basis of the scenes, images and/or audio contained therein. For example, processor 104 could be programmed to the requested content to an off-site service that employs an artificial intelligence to search the content for scenes involving violence or rude language. The off-site service would then compute an equivalent rating and return it to MGA 102. AI systems adapted to analyze video and audio are well-known and will not be discussed further.

If the analysis failed to yield an equivalent rating (a negative outcome in step 218), the user would be denied access to the requested content (step 212). If the analysis successfully computed an equivalent content rating, the process continues with step 206 and the access will be granted or denied passed upon the content rating and the provision of a valid key code (steps 206- 212). If denied, processor 104 would generate an indication that the user has been denied access to the requested content. This indication can be audible and/or visual and can be delivered to the user via a user interface, such as television 108.

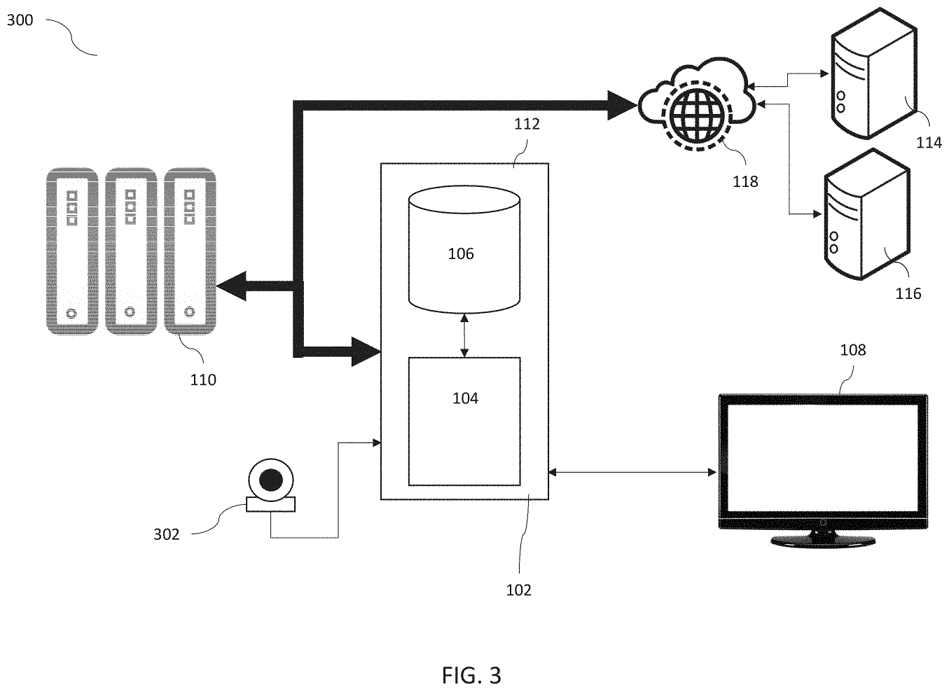

A system (300) supporting an alternate embodiment of the invention is depicted in FIG. 3. As shown this system shares many components with system 100 (FIG. 1), and the functionality of those shared components is much the same as those in system 100. However, system 300 includes biometric sensor 302 which is linked to MGA 102 so as to provide processor 104 with data indicative of user biometrics. This biometric data can be images, video, audio, retinal patterns, fingerprint data, etc. Biometric sensors capable of collecting such data are readily available.

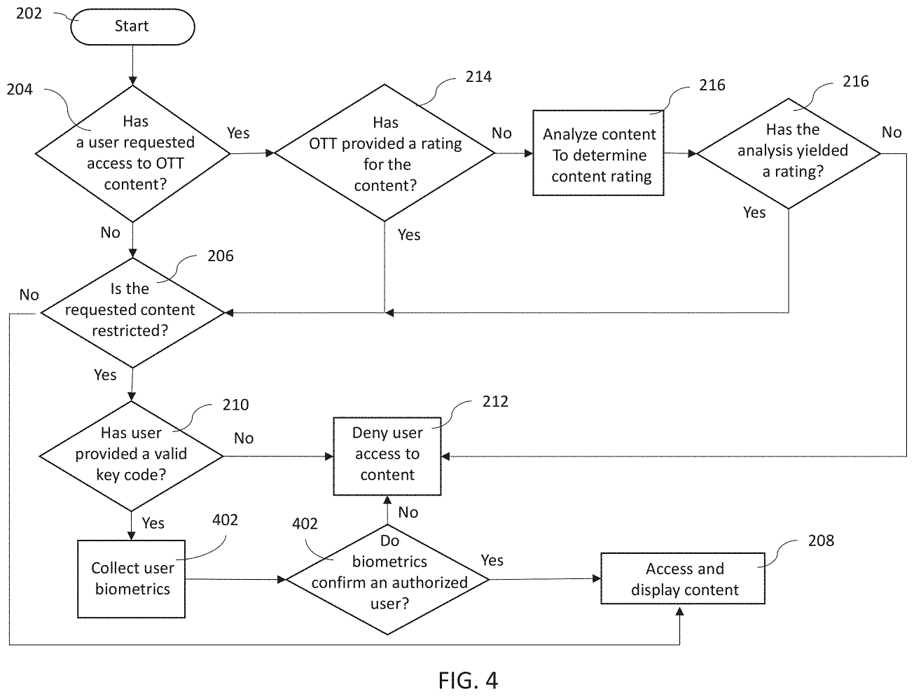

The operation of system 300 is similar to that of system 100, as evidenced by the flow diagram of FIG. 4 (steps 202-216 are shared between the processes depicted in FIGS. 1 and 4). However, the process depicted in FIG. 4 includes steps 402 and 404. In step 402, processor utilized biometric sensor 302 to collect information on the user making the content request. This collection may include recording a video or an image of the user, capturing the audio of the user recite a particular phrase; requesting the user place their finger or fingers on a pad so as to capture fingerprint data, etc. This captured biometric data is then a) compared by processor 104 to known user biometric data stored in memory 106, or b) sent by processor 104 to an AI system adapted to analyze biometrics so as to determine if the user's identity is consistent with the identity of an authorized user. For example, if all the authorized users stored in memory 106 are adults and the requesting user is found to be a child there would be an inconsistency. Or if the authorized users were identified by the data in memory 106 as having brown eyes and the requesting party had blue eyes—Inconsistency. If all authorized users were female and the requesting user was identified as a male—Inconsistency. The AI system would return particular identifying indicia to processor 104 which would make the comparison.

If the requesting party can be positively identified as a user authorized to access restricted content (such as an adult), there is an affirmative result in step 402 and access to the content is granted (step 208). If, however, step 402 results in a negative outcome, the user is denied access (step 212). Processor 104 will then generate an indication that the user has been denied access to the requested content. This indication can be audible and/or visual and can be delivered to the user via a user interface, such as television 108.

Although the invention herein has been described with reference to particular embodiments, it is to be understood that these embodiments are merely illustrative of the principles and applications of the present invention. For example, the processor and/or memory associated with a given MGA could be located external to the MGA, including in a cloud or networked environment. In addition, the MGAs described above can be stand-alone devices such as a set-top boxes, or integrated into another system or device such as a television or a computer. Also, the automated systems for analyzing content and/or biometric user data could include expert systems, as well as artificial intelligence systems. All of the above variations and extensions could be implemented and practiced without departing from the spirit and scope of the present invention as defined by the appended claims.

1. A system for prohibiting access to over-the-top content, the system comprising:
at least one source of non-over-the-top content;
at least one source of over-the-top content;
at least one media gateway appliance, comprising at least one processor and at least one memory, wherein the memory is adapted to store data indicative of user-specific content restrictions; and
at least one network linking the at least one source of non-over-the-top content and the at least one source of over-the-top content to the at least one media gateway appliance;
wherein the at least one media gateway appliance is adapted to:
receive a request from a user for access to over-the-top content;
determine if the at least one source of over-the-top content has provided an associated rating for the requested over-the-top-content;
restrict access to the requested over-the-top-content based, at least in part, on the data indicative of user-specific content restrictions and the rating provided by the at least one source of over-the-top content; and
require the user to provide the at least one processor with a code before granting access to any over-the-top content determined to be restricted, wherein the code is identical to a code utilized to access non-over-the-top content via the media gateway appliance.

2. The system of claim 1 wherein the media gateway appliance comprises at least one of the following:
a set-top box;
a television; and
a computer.

3. The system of claim 1 wherein the at least one processor is further adapted to provide the requesting user with an indication via a user interface that access to the requested over-the-top content has been denied.

4. The system of claim 1 further comprising:
at least one biometric sensor coupled to the at least one processor and adapted to collect biometric data from the user requesting over-the-top content; and
wherein the at least one processor is further adapted to:
verify that the requesting user should be granted access to restricted over-the-top content based, at least in part, on the collected biometric data.

5. The system of claim 4 wherein the collected biometric data comprises information indicative of at least one of the following:
the requesting user's voice;
the requesting user's fingerprint;
the requesting user's height;
the requesting user's eye color;
the requesting user's retinal pattern; and
the requesting user's sex.

6. A system for prohibiting access to over-the-top content, the system comprising:
at least one source of non-over-the-top content;
at least one source of over-the-top content;
at least one media gateway appliance, comprising at least one processor and at least one memory, wherein the memory is adapted to store data indicative of user-specific content restrictions; and
at least one network linking the at least one source of non-over-the-top content and the at least one source of over-the-top content to the at least one media gateway appliance;
wherein the at least one media gateway appliance is adapted to:
receive a request from a user for access to over-the-top content;
determine that the at least one source of over-the-top content has failed to provide an associated rating for the requested over-the-top-content;
determine an equivalent content rating based, at least in part, on determine if access to the requested over-the-top-content is restricted based, at least in part on, an analysis of the requested over-the-top content;
restrict access to the requested over-the-top-content based, at least in part, on the data indicative of user-specific content restrictions and the determined equivalent content rating; and
require the user to provide the at least one processor with a code before granting access to any over-the-top content determined to be restricted, wherein the code is identical to a code utilized to access non-over-the-top content via the media gateway appliance.

7. The system of claim 6 wherein the media gateway appliance comprises at least one of the following:
a set-top box;
a television; and
a computer.

8. The system of claim 6 wherein the at least one processor is further adapted to provide the requesting user with an indication via a user interface that access to the requested over-the-top content has been denied.

9. The system of claim 6 further comprising:
at least one biometric sensor coupled to the at least one processor and adapted to collect biometric data from the user requesting over-the-top content; and
wherein the at least one processor is further adapted to:
verify that the requesting user should be granted access to restricted over-the-top content based, at least in part, on the collected biometric data.

10. The system of claim 9 wherein the collected biometric data comprises information indicative of at least one of the following:
the requesting user's voice;
the requesting user's fingerprint;
the requesting user's height;
the requesting user's eye color;
the requesting user's retinal pattern; and
the requesting user's sex.

11. A method for prohibiting access to over-the-top content within a system comprising:
at least one source of non-over-the-top content;
at least one source of over-the-top content;
at least one media gateway appliance, comprising at least one processor and at least one memory, wherein the memory is adapted to store data indicative of user-specific content restrictions; and
at least one network linking the at least one source of non-over-the-top content and the at least one source of over-the-top content to the at least one media gateway appliance;
the method comprising the steps of:
receiving a request from a user for access to over-the-top content;
determining if the at least one source of over-the-top content has provided an associated rating for the requested over-the-top-content;
restricting access to the requested over-the-top-content based, at least in part, on the data indicative of user-specific content restrictions and the rating provided by the at least one source of over-the-top content; and
requiring the user to provide the at least one processor with a code before granting access to any over-the-top content determined to be restricted, wherein the code is identical to a code utilized to access non-over-the-top content via the media gateway appliance.

12. The method of claim 11 wherein the media gateway appliance comprises at least one of the following:
a set-top box;
a television; and
a computer.

13. The method of claim 11 wherein the at least one processor is further adapted to provide the requesting user with an indication via a user interface that access to the requested over-the-top content has been denied.

14. The method of claim 11 further comprising:
at least one biometric sensor coupled to the at least one processor and adapted to collect biometric data from the user requesting over-the-top content; and
wherein the at least one processor is further adapted to:
verify that the requesting user should be granted access to restricted over-the-top content based, at least in part, on the collected biometric data.

15. The method of claim 14 wherein the collected biometric data comprises information indicative of at least one of the following:
the requesting user's voice;
the requesting user's fingerprint;
the requesting user's height;
the requesting user's eye color;
the requesting user's retinal pattern; and
the requesting user's sex.

16. A method for prohibiting access to over-the-top content in a system comprising:
at least one source of non-over-the-top content;
at least one source of over-the-top content;
at least one media gateway appliance, comprising at least one processor and at least one memory, wherein the memory is adapted to store data indicative of user-specific content restrictions; and
at least one network linking the at least one source of non-over-the-top content and the at least one source of over-the-top content to the at least one media gateway appliance;
the method comprising the steps of:
receiving a request from a user for access to over-the-top content;
determining that the at least one source of over-the-top content has failed to provide an associated rating for the requested over-the-top-content;
determining an equivalent content rating based, at least in part, on determine if access to the requested over-the-top-content is restricted based, at least in part on, an analysis of the requested over-the-top content;
restricting access to the requested over-the-top-content based, at least in part, on the data indicative of user-specific content restrictions and the determined equivalent content rating; and
requiring the user to provide the at least one processor with a code before granting access to any over-the-top content determined to be restricted, wherein the code is identical to a code utilized to access non-over-the-top content via the media gateway appliance.

17. The method of claim 16 wherein the media gateway appliance comprises at least one of the following:
a set-top box;
a television; and
a computer.

18. The method of claim 16 wherein the at least one processor is further adapted to provide the requesting user with an indication via a user interface that access to the requested over-the-top content has been denied.

19. The method of claim 16 further comprising:
at least one biometric sensor coupled to the at least one processor and adapted to collect biometric data from the user requesting over-the-top content; and
wherein the at least one processor is further adapted to:
verify that the requesting user should be granted access to restricted over-the-top content based, at least in part, on the collected biometric data.

20. The method of claim 19 wherein the collected biometric data comprises information indicative of at least one of the following:
the requesting user's voice;
the requesting user's fingerprint;
the requesting user's height;
the requesting user's eye color;
the requesting user's retinal pattern; and
the requesting user's sex.
